(19) United States
(12) Patent Application Publication
(10) Pub. No.: US 2024/0116049 A1
(43) Pub. Date: Apr. 11, 2024

(54) L-Shaped Cartridge

(71) Applicant: Robert Bosch GmbH, Stuttgart (DE)

(72) Inventors: Jochen Feichtinger, Ilsfeld-Helfenberg (DE); Jochen Hoffmann, Renningen (DE); Daniel Sebastian Podbiel, Rutesheim (DE)

(21) Appl. No.: 18/554,777

(22) PCT Filed: Mar. 4, 2022
(86) PCT No.: PCT/EP2022/055552

§ 371 Date: Oct. 10, 2023

(30) Foreign Application Priority Data
Apr. 13, 2021 (DE) 10 2021 203 617.1

(51) Int. Cl. B01L 3/00

(52) U.S. Cl. CPC B01L 3/502715; B01L 3/502707; B01L 2200/025; B01L 2200/027; B01L 2300/0816; B01L 2400/0457

(57) ABSTRACT

A microfluidic cartridge has an L-shaped base. The base is based on a rectangle and a corner region of the rectangle is missing, so that the microfluidic cartridge is positionable relative to a second microfluidic cartridge having the same base, such that a respective projection of the base of the microfluidic cartridge engages in the missing corner region of the base of the second microfluidic cartridge.

### PRIOR ART

Microfluidic analysis systems (so-called lab-on-chips or LOCs) enable automated, reliable, fast, compact and cost-effective processing of patient samples for medical diagnostics. By combining a variety of operations for controlled manipulation of fluids, complex molecular diagnostic test sequences can be carried out on a lab-on-chip cartridge, wherein the often passive cartridge is operated via a processing unit. For instance, DE 10 2016 222 075 A1 and DE 10 2016 222 072 A1 both describe a microfluidic system comprising a cartridge for receiving a biological sample and a processing unit for processing the sample in the cartridge, for example to detect pathogens in the sample.

Lab-on-chip cartridges can be produced cost-efficiently from polymers using series production processes such as injection molding, punching or laser transmission welding.

The degree of complexity of a molecular diagnostic test sequence can vary depending on the chosen application. The requirements placed on a lab-on-chip cartridge therefore also differ depending on the application. In addition to providing a particularly universal cartridge that addresses a particularly wide range of applications, providing particularly cost-efficient cartridges that have an adapted, requirements-optimized range of applications is especially useful. This raises the question of a particularly advantageous configuration for such cartridges.

### DISCLOSURE OF THE INVENTION

### Advantages of the Invention

In light of this, the invention relates to a cartridge, wherein a base of the cartridge has an L-shape.

The cartridge can in particular be a microfluidic cartridge, in terms of type and intended use in particular based on a cartridge described in DE 10 2016 222 075 A1 or DE 10 2016 222 072 A1 and shown in Community Design No. 3459379, for instance, wherein, deviating from the rectangular base, the cartridge according to the invention has an L-shaped base. The cartridge according to the invention can in particular also be configured as part of a microfluidic system for the (partly) automated implementation of microfluidic processes for replication and/or analysis of biological entities, in particular for the replication and detection of (parts of) nucleic acids, for example for the detection of pathogens.

The base can in particular but not necessarily be a surface of the cartridge, in particular the underside; in the case of a plate-shaped or layered structure of the cartridge, a base plate for instance. The base can in particular be a maximum extension of the cartridge in a plane, in particular in the plane in which an area or length covered by the cartridge is maximum. The base can alternatively also be a cross-section through the cartridge, in particular a cross-section in a plane in which the cartridge has a maximum area and/or a maximum length as described above.

An L-shape can in particular be understood to mean that the shape of the base is based on the shape of a bold capital letter L. The base can preferably resemble a bold L, wherein the horizontal stroke of the L is bolder than the vertical stroke of the L, preferably 1.1 to 2.5 times bolder, most preferably 1.5 to 2.1 times bolder, for example 1.9 times bolder, so that the base resembles a bold L with shortened vertical stroke. The two strokes can also be referred to in the following as arms of the letter L or as arms of the base. The base of the cartridge thus preferably approximates the shape of the letter L, wherein the width of the part of the base corresponding to the vertical stroke of the L can be significantly larger than the width of the part of the base corresponding to the horizontal stroke of the L. The letter L can in particular also be understood as the vertically mirrored letter L, so that the horizontal stroke of the letter does not extend to the right, but rather to the left, starting from the vertical stroke.

The L-shape can preferably also be understood to mean that the cartridge has a base based on a rectangle, wherein a corner region of the rectangle is missing, so that the cartridge can be disposed relative to a second cartridge having the same base such that a respective projection of the base of one cartridge engages in the missing corner region of the base of the other cartridge. One or more corners of the base can be rounded, so that the base is accordingly based on a rectangle with a missing corner region and rounded corners. The missing corner region can preferably be based on a shape of a square, a rectangle or a trapezoid or correspond to such a shape. In the case of the trapezoid, one leg of the trapezoid, which would correspond to a part of an outer edge of the base, is preferably at a right angle to each of the base sides of the trapezoid, so that the trapezoid has only one side, that is not at a right angle to the adjacent other sides. Due to this missing corner region and the resulting projection, the base of the cartridge therefore preferably has (approximately) the shape of the letter L. In other words, the base is preferably based on a rectangle, in which a corner region of the rectangle is missing, so that a region that remains as a result of the missing corner region (i.e., the aforementioned projection) can engage in the missing corner region of a second cartridge having the same base. The projection and the missing corner region can thus preferably also have the same or at least similar dimensions or shapes; in particular the area of the projection and the area of the missing corner region can have the same or similar dimensions or shapes. According to one advantageous configuration, similar dimensions can be understood to mean that the area of the projection and the area of the missing corner region are similar in the geometrical sense, i.e., can be converted into one another by a similarity mapping. Similar dimensions can furthermore preferably be understood to mean that the area of the projection is smaller than the area of the missing corner region, such that, in an opposite arrangement of two cartridges having the same projections, wherein the projections engage in the respective missing corner regions of the other cartridge and wherein the outer edges of the cartridges are disposed along common alignment lines, a gap remains between the projections. The area of the projection can, for instance, be 1 to 10% or 1 to 5% smaller than the area of the missing corner region.

The invention advantageously provides a cartridge which, on the one hand, can be produced in a resource-conserving manner and in significantly less time and compactly stored and transported and, on the other hand, enables advantageous microfluidic processing of a sample fluid inside the microfluidic apparatus using gravity-based processes.

The configuration according to the invention of the base makes a particularly advantageous 2-in-1-production possible. In particular exactly two cartridges can be oriented opposite to one another and interlocking and can thus be produced in a parallelized manner on a particularly small area. This makes particularly cost-effective and efficient production of the L-shaped cartridge possible.

In particular two oppositely oriented cartridges or also semi-finished products for producing the cartridges can be processed on a surface of a workpiece carrier which corresponds to the surface of a second, in particular rectangular-shaped, cartridge or semi-finished products for producing the second cartridge. This advantageously makes it possible to flexibly use an already existing production line for the production of at least two different cartridge types without major adjustments.

In an oppositely oriented arrangement of a respective pair of cartridges or a pair of semi-finished products having the base according to the invention for producing the cartridges, the configuration according to the invention of the cartridge furthermore also enables a particularly space-saving and compact storage and transport of large quantities of the cartridge or semi-finished products for producing the cartridge. The space required for autoclaving the cartridges or semi-finished products can moreover be significantly reduced.

It is also particularly advantageous that, despite its compact size which is reduced compared to that of known cartridges, the cartridge according to the invention and in particular the base of the cartridge have a high aspect ratio. By maintaining the comparatively large length of the cartridge, the gravitational force of the earth can be used to transport fluids along the entire length if the cartridge is appropriately inclined in the gravitational field. In other words, gravity-based functions, such as gravity-based collection of a liquid at the lower end of a liquid reagent prestorage chamber or discharging gas bubbles in a microfluidic chamber by means of the buoyancy force acting upon it, can advantageously be exploited in a particularly advantageous manner.

In gravity-based microfluidic processing, there is thus in particular no significant technical disadvantage over a, for instance, larger-area, rectangular-shaped cartridge having a comparable vertical spatial extent. Due to the reduced material requirement, however, the cartridge according to the invention is particularly resource-conserving and sustainable, because the amount of waste for disposal is reduced in comparison to entirely rectangular-shaped cartridges.

The retained length and the associated projection of the base moreover support backward compatibility of the cartridges according to the invention in processing devices that are configured to process cartridges of the same or a similar length.

The invention furthermore provides a particularly advantageous shape of the cartridge for implementing a microfluidic network in the cartridge, wherein the microfluidic network comprises, for example fluidic and pneumatic, microchannels, as well as active microfluidic elements such as valves and pump chambers which can be actuated via the pneumatic microchannels and in particular a pneumatic interface for controlling the active microfluidic elements that is located in the part of the cartridge that is particularly wide in the horizontal direction.

The L-shape and in particular the associated projection of the cartridge also have the advantage that there are several options for the user to grab and grip the cartridge in different ways. Depending on the actual size ratios, the user can robustly grasp the cartridge at the narrower projection in a comparatively large configuration and at the wider end in a small configuration. The L-shape of the cartridge thus enables particularly simple, safe and comfortable handling by the user, for example when placing a sample into the cartridge or when placing the cartridge into a processing unit.

According to a particularly preferred further development of the invention, the projection has a width which tapers at least in sections. Such a tapering width can in particular be implemented by means of two longitudinal sides of the projection, wherein a first longitudinal side and a second longitudinal side converge along the projection. Such tapering can further facilitate the handling of the cartridge for the user, because it provides different widths for different sized hands. Two cartridges having the same base can furthermore be disposed compactly in an even more simple manner oriented opposite to one another and interlocking as described above. In other words, one of the two arms of the cartridge extends at a predetermined angle in such a way that its cross-sectional area decreases from the point of attachment of the second arm toward the end edge of the arm of the cartridge.

A longitudinal side (edge) and a transverse side (edge) of the base can preferably form an angle greater than 90 degrees, i.e., an obtuse angle, to one another. As a result, the projection can have a width which tapers at least in sections as described above.

In a particularly advantageous further development of the invention, the projection comprises a second projection. The second projection is preferably smaller than the first projection, and the second projection is preferably disposed on a front side of the first projection so that the second projection extends a length of the cartridge. Such a second projection has the advantage that the second projection can be used to activate an interaction with the processing unit when the cartridge is received into the processing unit. The second projection can trigger a mechanical actuation in the processing unit, for instance. Alternatively or additionally, the second projection can advantageously be used to ensure correct reception in the processing unit, for example as part of an anchoring or locking of the cartridge, for example in that the second projection engages (preferably in a form-locking manner) in a recess or groove in the processing unit. Alternatively or additionally, correct placement of the cartridge in the processing unit can advantageously be determined via optical or tactile detection of the second projection.

According to one advantageous configuration, the ratio of a length of a first dimension of the cartridge and a length of a second dimension of the cartridge is between 1.4 and 2.0, preferably between 1.5 and 1.7, most preferably between 1.58 and 1.65, for example in the golden ratio of (approximately) 1.618. The first dimension and the second dimension can in particular be parallel dimensions of the cartridge, in particular the length of the first arm (i.e., the length of the vertical stroke of the bold letter L) or the width of the second arm (i.e., the width of the horizontal stroke of the bold letter L).

As already stated above, in preferred embodiments of the invention one or more corners of the cartridge can be rounded, in particular one or more corners of the base. This has the advantage that it reduces the risk of injury from sharp edges when using the cartridge. The rounded corners can furthermore facilitate insertion of the cartridge into a processing unit. Rounded corners moreover give the user a more comfortable feeling when handling the cartridge. Mechanical forces, which can occur when a corner of the cartridge impacts another object, for example, can also be better dissipated within the cartridge and the risk of crack formation can be reduced.

In another particularly advantageous embodiment, the cartridge comprises interfaces for processing in a processing unit, wherein the processing unit can also be embodied as an analysis device. The interfaces can be disposed at the same positions as in a second, for example rectangular-shaped, cartridge, which can be processed in the same processing unit. Both cartridge types can thus particularly advantageously be processed in the same processing unit or analysis device.

The subject matter of the invention is also an apparatus comprising a first cartridge according to the invention and a second cartridge having the same base, wherein the two cartridges are connected to one another such that a respective projection of the base of one cartridge engages in the missing corner region of the base of the other cartridge. The second cartridge can in particular also be a cartridge according to the invention. The two cartridges can preferably be connected via a connecting piece, wherein the connecting piece is preferably connected to the respective projections of the cartridges. This apparatus has the advantage that two cartridges can be used in a compact manner, in particular transported and stored in a simple manner, and separated from one another just before their intended use.

The subject matter of the invention is also a method for producing a cartridge according to the invention. In a first step, two semi-finished products are placed on a workpiece carrier, wherein the semi-finished products have an L-shaped base. The semi-finished products can in particular be L-shaped plastic base plates of the cartridges. The two semi-finished products are preferably disposed relative to one another such that they are oppositely oriented and interlock as described above. The two semi-finished products can also be physically connected to one another, for example as a result of an injection molding process. In a second step, the two semi-finished products are processed in parallel, wherein the processing includes equipping the semi-finished products with further parts. Parallel processing can in particular be understood to mean that the two semi-finished products are subjected to further production steps at the same pace, preferably at the same time. According to a third step of the method, each of the two semi-finished products is fitted with a further semi-finished product before the two semi-finished products are separated into two cartridges having an L-shaped basic shape in a fourth step. The semi-finished products can be fitted using a series production technology such as laser transmission welding, for example. Separation can generally be understood to be spatial separation of the two cartridges, but also a physical separation of parts of the two cartridges that were connected to one another via a common material, for example as a result of an injection molding process. The L-shape of the bases thus makes it possible to produce two cartridges according to the invention in parallel in a compact and time-saving manner.

The subject matter of the invention is furthermore a method for processing a cartridge according to the invention, for example with a processing unit that is based on a processing unit for inclined processing of cartridges, for instance as disclosed in DE 10 2016 222 075 A1 and DE 10 2016 222 072 A1. Inclined processing is in particular understood to mean that the cartridge is aligned parallel or at an angle to the direction of gravity when processed by the processing unit as intended. For this purpose, the processing unit can preferably have a receptacle and vertical or oblique fixation of the cartridge with respect to the earth's gravitational field as described in DE 10 2016 222 075 A1 and DE 10 2016 222 072 A1. Due to the L-shape of the cartridge, the non-vanishing component of the gravitational field can particularly advantageously be used to transport fluid in the cartridge and/or to actuate or support elements, such as valves or pumps, as stated above.

Regarding the advantages of the methods according to the invention, reference is also made to the corresponding advantages of the cartridge according to the invention mentioned above.

### BRIEF DESCRIPTION OF THE DRAWINGS

Embodiment examples of the invention are shown schematically in the drawings and explained in more detail in the following description. The same reference signs are used for the elements which are shown in the various figures and have a similar effect, whereby a repeated description of these elements is omitted.

The figures show:

FIGS. 1, 2 embodiment examples of the cartridge according to the invention and the apparatus according to the invention and

FIGS. 3, 4 flow charts of embodiment examples of the production method or processing method according to the invention.

### EMBODIMENTS OF THE INVENTION

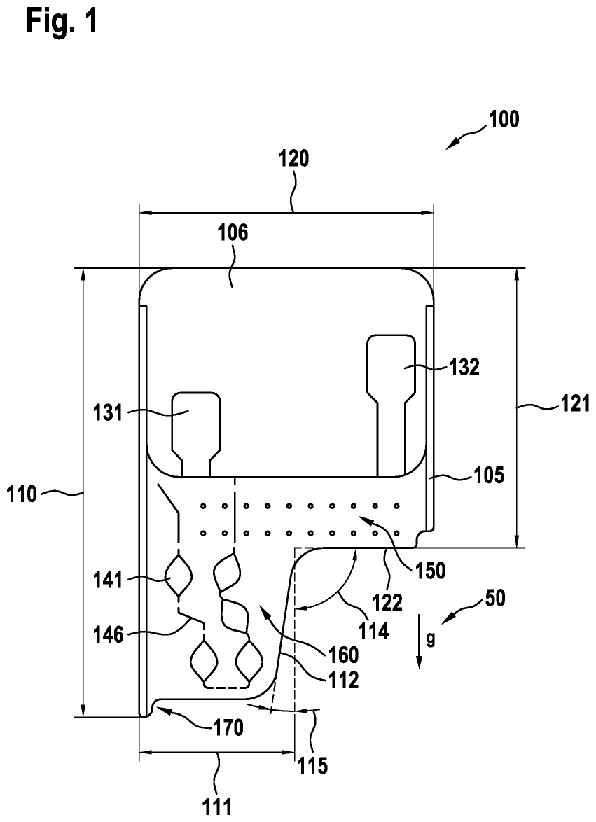

FIG. 1 shows a schematic illustration of a view onto the upper side of a cartridge 100 according to the invention in a first embodiment example. The cartridge 100 has an L-shaped base 105, wherein, in this example, a base plate 105 encloses the base 105 and the base 105 thus corresponds to the underside of the cartridge 100. A cover 106 comprising a rectangular upper side and rounded corners is disposed on the base plate 105. Further layers, plates or coatings can be disposed between the base plate 105 and the cover 106 as parts of a multipart structure of the cartridge 100.

For naming purposes, the cartridge 100 and also the base 105 can mentally be divided into an approximately rectangular first arm of the length 110 and width 111 and a perpendicular approximately rectangular second arm of the length 120 and width 121, wherein the first arm resembles the vertical stroke of a bold capital letter L and the second arm resembles the horizontal stroke of a bold letter L. In other words, the L-shaped cartridge 100 has a first vertical dimension 110 which corresponds to a length of the first arm and a first horizontal dimension 120 which corresponds to a length of the second arm. The cartridge 100 also has a second horizontal dimension 111 which corresponds to a width of the first arm and a second vertical dimension 121 which corresponds to a length of the second arm. The base 105 of the cartridge 100 thus approximates two rectangles (corresponding to the aforementioned arms) that are at right angles to one another and partially overlap, so that the base 105 has the shape of a bold letter L or resembles the base of the “angle” tool. In other words, in a first approximation, the base 105 corresponds to two rectangular legs disposed at right angles. The portion of the first arm that extends beyond the second arm is also referred to hereinafter as the projection 160 of the cartridge 100.

The shape of the base 105 can also be considered to be based on a rectangle with a corner region of the rectangle missing. In the embodiment example shown in FIG. 1, the missing corner region approximates a trapezoid adjoining the projection 160, wherein a leg which would correspond to an extension of the second vertical dimension 121 forms a 90 degree angle with each of the two base sides of the trapezoid.

As shown in FIG. 1, the first arm of the cartridge 100, in particular the projection 160, can have a width 111 that tapers in sections along the first vertical dimension 110. Such a tapering can in particular be implemented by means of an obtuse angle 114, i.e., an angle greater than 90 degrees, between two edges 112, 122 of the cartridge 100, wherein the first edge 112 delimits the first arm, in particular the projection 160, from the first vertical dimension 110, and wherein the second edge 122 delimits the second arm from the first horizontal dimension 120. The angle 114 can have a value between 90 and 135 degrees, for instance, preferably between 92 and 110 degrees, for example 98 degrees. Alternatively to the angle 114, the tapering can also be defined by an angle 115 between the first edge 112 and a line 113 parallel to the first vertical dimension 110, wherein the angle can have a value between 0.1 and 45 degrees, preferably between 2 and 20 degrees, for example 8 degrees. The first arm of the cartridge 100 thus in particular tapers at a predetermined angle 114 such that the width 111 of the portion of the base 105 associated with the first arm decreases from the point of attachment of the second arm, i.e., the width 111 of the projection 160, toward the end of the first arm of the cartridge.

As also shown in FIG. 1, the projection 160 can comprise a second projection 170, wherein the second projection 170 is preferably disposed on a front side of the first projection 160, in particular on the edge of the second horizontal dimension 111 of the first projection 160, or on the edge which delimits the width 111 of the first arm. The second projection 170 can be used to activate a function or ensure correct alignment when the cartridge 100 is placed into the processing unit, for instance.

The dimension of the rectangle on which the shape of the base 105 is based can be 20×10 square millimeters (mm²) to 300×200 mm², for instance, preferably 50×20 mm² to 200×100 mm², for example 118×78 mm². A length of the first arm 110 or the first vertical dimension 110 is 20 millimeters (mm) to 300 mm, for instance, preferably 50 mm to 200 mm, for example 118 mm. A width of the first arm 111 or the second horizontal dimension 111 is 20 mm to 100 mm, for instance, preferably 35 mm to 75 mm, for example 40 mm. A length of the second arm 120 or the first horizontal dimension 120 is 20 mm to 150 mm, for instance, preferably 35 mm to 125 mm, for example 78 mm. A width of the second arm 121 or the second vertical dimension 121 is 20 mm to 150 mm, for instance, preferably 35 mm to 125 mm, for example 73 mm. In the shown embodiment example, the ratio of the first vertical dimension 110, for example 118 mm, and the second vertical dimensions 121, for example 73 mm, corresponds approximately to 1.618 and thus the golden ratio, which provides this embodiment example of the cartridge 100 with an appearance that is perceived as particularly aesthetic. In other embodiment examples, the ratio is 1.4 to 2.0, for instance, preferably 1.5 to 1.7 and most preferably 1.58 to 1.65, i.e., approximately 1.618. The ratio of the first vertical dimension 110 and the first horizontal dimension 120 is likewise 1.4 to 2.0, for instance, preferably 1.5 to 1.7 and most preferably 1.58 to 1.65, i.e., approximately 1.618.

The cartridge 100 preferably comprises one or two sample input chambers 131, 132 for the placement of an in particular biological sample as described above. The covers of the sample input chambers 131, 132 can be part of the cover 106 of the cartridge 105, wherein the cover 106 of the cartridge 100 covers a region of the base 105 as shown in FIG. 1 and already described above. As further shown in FIG. 1, the cartridge 100 comprises a pneumatic interface 150 which includes, for example twenty pneumatic port openings. As shown, the pneumatic interface 150 is implemented in particular in the region of the second arm between the cover 106 and the projection 160. The configuration of the first arm of the cartridge at a taper angle 115 is therefore particularly advantageous for contacting the active microfluidic elements in that arm to the pneumatic interface 150 via pneumatic channels.

The cartridge 100 preferably also comprises one or more microfluidic chambers 141, which are connected via microfluidic channels 146 and in which sections of nucleic acids can be replicated, for instance, for example using a polymerase chain reaction. With transparent material, the chambers 141 can be visible on the upper side of the cartridge 100 as shown in order to observe and read out a reaction occurring in the chambers 141. As shown, the chambers 141 can in particular be located in the projection 160. This has the advantage that a sample placed using the sample input chambers 131, 132 can be processed along the entire length 110 of the cartridge 100 between the sample input chamber 131, 132, and the chambers 141. In the case of an oblique or vertical orientation of the cartridge 100 in a gravitational field 50 such as the earth's gravitational field, a non-vanishing force component of the gravitational field 50 along the first vertical dimension 110, i.e., along the first arm, can thus advantageously be used to transport the sample and other reagents in the cartridge 100. The liquids for processing within the cartridge 100 can be aqueous solutions, for instance, for example buffer solutions, in particular containing components of a sample substance, as well as mineral oils, silicone oils or fluorinated hydrocarbons.

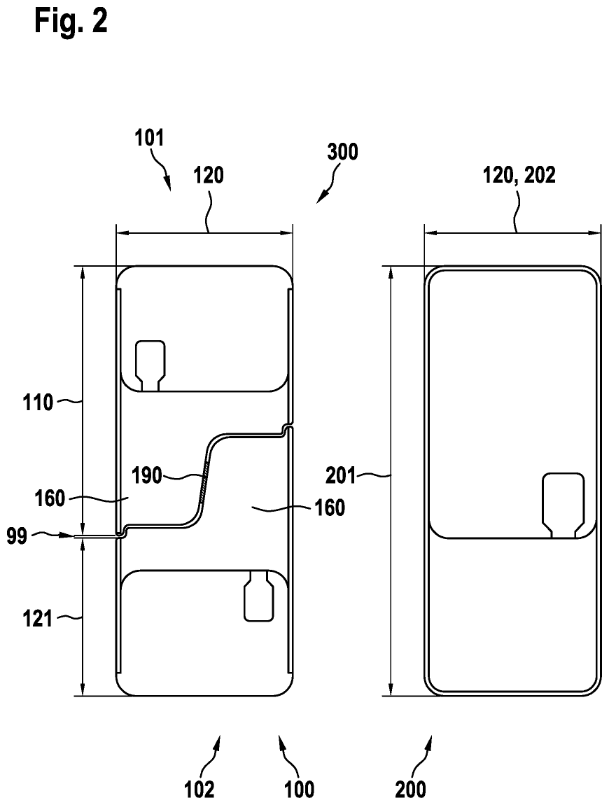

FIG. 2 shows a further embodiment example which comprises two aligned cartridges 101, 102 according to the invention. One or both of the cartridges 101, 102 can be the embodiment example of the cartridge 100 shown in FIG. 1.

As shown on the left in FIG. 2, the two cartridges 101, 102 are aligned with one another such that a respective projection 160 of one cartridge 101, 102 engages in the missing corner region of the base of the other cartridge 101, 102 spaced apart by a comparatively narrow gap 99 having a constant width. In other words, the two cartridges 101, 102 are oppositely oriented, so that the second cartridge 102 is rotated 180 degrees relative to the first cartridge 101. In terms of their area, the projections 160 can be embodied somewhat smaller than the areas of the respective missing corner regions, so that, despite the arrangement of the two cartridges 101, 102 along common alignment lines, wherein the alignment lines overlap the edges of the vertical dimensions 110, 121, a gap 99 remains at or between the projections 160. This arrangement illustrates several advantages of the cartridge according to the invention. As shown, two respective cartridges 101, 102 according to the invention can be compactly disposed and stored. The dimensions of the cartridge 100, 101, 102 according to the invention are furthermore preferably configured such that the sum of the bases of the thus disposed cartridges 101, 102, apart from the gap 99, corresponds to the base of a previous rectangular cartridge 200 (shown on the right in FIG. 2). As shown, the sum of the first vertical dimension 110, the width of the gap 99 and the second vertical dimension 121 corresponds to a vertical dimension 201 of the rectangular cartridge 200. In this example, the first horizontal dimension 120, i.e., the width of the cartridge 100, 101, 102 according to the invention, also corresponds to the width 202 of the rectangular cartridge 200. In other words, a surface area of the base of the rectangular cartridge 200 corresponds to a length 120 of the second arm of the cartridge 100, 101, 102 according to the invention times the sum of the length 110 of the first arm plus a width of the gap 99 plus the width 121 of the second arm.

The two cartridges 101, 102 can also be connected to one another, preferably via a connecting piece 190 which can be made of the same material as a base plate or other layer of the cartridge, for example, and connects the two projections 160 of the cartridges 101, 102 across the gap 99. FIG. 2 thus also shows an embodiment example of the apparatus 300 according to the invention. The apparatus 300 comprises a first cartridge 101 according to the invention and a second cartridge 102 having the same base, wherein the two cartridges 101, 102 are connected to one another such that a respective projection 160 of the base of a cartridge 101, 102 engages in the missing corner region of the base of the other cartridge 102, 101.

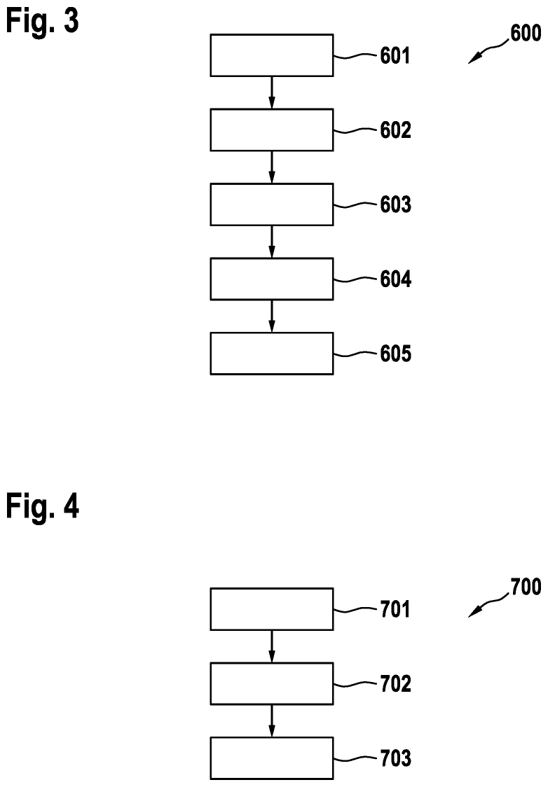

FIG. 3 shows a flow chart of an embodiment example of the production method 600 according to the invention, for example for producing one of the cartridges 100, 101, 102 shown in FIG. 1 or 2.

In the first step 601 of the method 600, two L-shaped semi-finished products are disposed on a workpiece carrier. The semi-finished products can be plastic base plates of the cartridges 100, 101, 102 produced by means of an injection molding process, for example. The semi-finished products can in particular be of the same type and disposed in opposite orientation; in other words, the second semi-finished product is rotated 180 degrees relative to the first semi-finished product. The arrangement of the semi-finished products can already be defined during the production of the semi-finished products, for example. In a special embodiment, the two semi-finished products are mechanically connected to one another, for example as a result of a common injection molding process, so that the two semi-finished products can be handled as a cohesive piece. The latter can be advantageous to enable the cartridge 100 to be produced in the most automated, efficient and cost-effective manner possible.

In the second step 602 of the method 600, the semi-finished products disposed on the workpiece carrier are processed in a parallelized manner. The semi-finished products are transported to a special manufacturing station, for instance, and/or the semi-finished products are equipped with additional parts and/or combined with other semi-finished products. Equipping with additional parts can be accomplished by inlaying, inserting or attaching and/or snapping, for example. Combining with other semi-finished products can be accomplished by placing the other semi-finished products on the semi-finished products located on the workpiece carrier, for example. As already explained, in a particularly advantageous embodiment, the semi-finished products or also other parts are mechanically connected to one another as a common part in order to achieve particularly simple handling. In a further advantageous embodiment, the tool carriers have alignment pins which engage in alignment through-holes in the semi-finished products in order to achieve a defined positioning of the semi-finished products on the workpiece carrier and a defined relative positioning of the semi-finished products with respect to the semi-finished products. The latter serves to prepare a subsequent step of fitting, for example.

In the third step 603 of the method 600, two respective semi-finished products located on the workpiece carrier are fitted with respective further two semi-finished products. The semi-finished products can preferably be fitted in parallel in order to achieve a particularly high throughput during production. The semi-finished products can be fitted using a series production technology such as laser transmission welding, for example.

In the optional fourth step 604 of the method 600, one or more of the preceding steps are repeated. The steps of disposing 601, processing 602 and fitting 603 are carried out multiple times, for example in order to produce multilayer cartridges 100, 101, 102 comprising inlaid parts and at least one attached cover element.

In the fifth step 605 of the method 600, the cartridges 100, 101, 102 made of the possibly mechanically connected semi-finished products or parts are separated in order to obtain two separate cartridges 100, 101, 102. Separating can be accomplished by mechanically breaking along predetermined breaking points, for example, or by means of another type of separating method. In further embodiments of the method 600 according to the invention, individual steps can be omitted or carried out repeatedly, or can be switched with other steps in the sequence.

The semi-finished products and other parts of the cartridge 100, 101, 102 can preferably include polymers, such as polycarbonate (PC), polystyrene (PS),

styrene acrylonitrile copolymer (SAN), polypropylene (PP), polyethylene (PE), cycloolefin copolymer (COP, COC), polymethyl methacrylate (PMMA), polydimethylsiloxane (PDMS) or thermoplastic elastomers (TPE) such as polyurethane (TPU) or styrene block copolymer (TPS), and can be produced by means of series production processes such as injection molding, thermoforming, punching or laser transmission welding, for example, in the course of the method 600 according to the invention.

FIG. 4 shows a flow chart of an embodiment example of the method 700 according to the invention for processing a cartridge 100, 101, 102 according to the invention, for example a cartridge 100, 101, 102 described in the above embodiment examples.

In the first step 701 of the method 700, the cartridge 100 is placed into a processing unit, in particular into an analysis device for analyzing a biological sample that can be processed in the cartridge 100, 101, 102. As described above, this can be a detection of pathogens in a body fluid (blood, sputum or smear) with the aid of a polymerase chain reaction or isothermal amplification to replicate nucleic acids of the pathogens, for instance. The sample can comprise a liquid, in particular an aqueous solution, for example obtained from a biological substance, for example of human origin, such as a body fluid, a smear, a secretion, sputum or a tissue sample. The sample may contain species having medical, clinical, diagnostic or therapeutic relevance, such as bacteria, viruses, cells, circulating tumor cells, cell-free DNA, proteins or other biomarkers, for example, or in particular components of said objects. The sample fluid is a master mix or components thereof, for example for carrying out at least one replication reaction as described above.

For processing, the cartridge 100, 101, 102 is preferably aligned at an angle to the earth's gravitational field in order to enable gravity-based microfluidic processing of liquids inside the cartridge 100, 101, 102. Such an orientation of the cartridge 100, 101, 102 allows a released liquid reagent to collect at the lower end of a prestorage chamber, for example, and from there to be further processed in the microfluidic network of the cartridge 100, 101, 102. The cartridge 100, 101, 102 is aligned such that an angle between a normal to the plane of the base and the direction of the gravitational field 50 is between 0 and 80 degrees, for instance, preferably 10 to 80 degrees, for example 30 degrees.

In the second step 702 of the method 700, the L-shaped cartridge 100, 101, 102 is processed in the processing unit, for example in order to process a sample therein as stated above.

In the third step 703 of the method 700, the cartridge 100, 101, 102 is output by the processing unit and an analysis result is preferably output as well.

1. A microfluidic cartridge, comprising:
a base having an L-shape.

2. The microfluidic cartridge according to claim 1, wherein:
the base is based on a rectangle and a corner region of the rectangle is missing, so that the microfluidic cartridge is positionable relative to a second microfluidic cartridge having the same base, such that a respective projection of the base of the microfluidic cartridge engages in the missing corner region of the base of the second microfluidic cartridge.

3. The microfluidic cartridge according to claim 2, wherein:
the projection comprises a sub-projection, and
the sub-projection is located on a front side of the projection.

4. The microfluidic cartridge according to claim 2, wherein:
the projection has a width which tapers at least in sections, and
a first longitudinal side and a second longitudinal side converge along the projection.

5. The microfluidic cartridge according to claim 2, wherein the projection is configured such that an area of the projection and an area of missing corner region have the same dimensions.

6. The microfluidic cartridge according to claim 1, wherein a longitudinal side and a transverse side of the base are at an angle greater than 90 degrees to one another.

7. The microfluidic cartridge according to claim 1, wherein a ratio of a length of a first dimension of the base and a length of a second dimension of the base is between 1.4 and 2.0.

8. The microfluidic cartridge according to claim 1, wherein one or more corners of the microfluidic cartridge are rounded.

9. An apparatus comprising:
a first microfluidic cartridge having a base defining an L-shape; and
a second microfluidic cartridge having a base defining the L-shape,
wherein the first microfluidic cartridge and the second microfluidic cartridge are connected to one another, such that a projection of the base of the first microfluidic cartridge engages in a missing corner region of the base of the second microfluidic cartridge.

10. A method for producing a microfluidic cartridge, comprising:
placing two semi-finished products on a workpiece carrier, the semi-finished products having an L-shaped base;
parallel processing the two semi-finished products, the parallel processing including equipping the semi-finished products with further parts;
fitting each of the two semi-finished products with a further semi-finished product; and
separating the two semi-finished products into two microfluidic cartridges each having an L-shaped base.

11. The method according to claim 10, wherein the two microfluidic cartridges are processed at an angle in a processing unit.
